(19) United States
(12) Patent Application Publication
(10) Pub. No.: US 2024/0311939 A1
(43) Pub. Date: Sep. 19, 2024

(54) ASSET MANAGEMENT SYSTEM SIMULATION

(71) Applicant: Brian Richard Fast, Kirtland, OH (US)

(72) Inventor: Brian Richard Fast, Kirtland, OH (US)

(21) Appl. No.: 18/518,944

(22) Filed: Nov. 24, 2023

Related U.S. Application Data
(60) Provisional application No. 63/427,459, filed on Nov. 23, 2022.

(51) Int. Cl. G06Q 50/163; G06Q 40/06

(52) U.S. Cl. CPC G06Q 50/163; G06Q 40/06

(57) ABSTRACT

Computer-implemented asset management system simulation methods, systems, and computer-readable media are described.

### FIELD

Some implementations are generally related to computerized simulation, and, more particularly, to methods and systems for performing a simulation within an asset management system.

### BACKGROUND

Managing assets, such as real estate assets, can often be a labor-intensive manual process that can involve decisions for which results may not be apparent for a considerable length of time.

A need may exist for a simulation method, including a method of controlling the system clock, within a computerized asset management system that can provide a training capability and an analysis tool to evaluate and test possible decisions in a time frame that is different than chronological real time. Further, a need may exist for simulation systems and methods for general business processes, software development, etc.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In general, some conventional business simulations, standalone programs or spreadsheets, exist for prediction purposes. However, the disclosed subject matter is focused on simulation systems and methods that are integrated into the “actual” business program used for actually running operations. Some implementations of the disclosed subject matter can include simulation methods and systems that include a system clock that can be manipulated including fast forwarding time, pausing time, running time at a faster or slower pace than real time, and jumping back in time, where some clock manipulations create alternate timelines within the software business application used for running actual operations. The software business application and simulation systems and methods disclosed herein can be applied to a variety of problem areas such as business, asset and property management, general ledger entries, task tracking and scheduling, business process tracking (such as work orders, quotes, purchase orders, invoices, payments which go to GL, payment orders such as ACH credit/debit and credit card processing), advertising and lead generation, and material tracking. In some implementations, the simulation can include leveraging or bypassing actual money or data transfer in simulation mode (e.g., sales, applications, contracts, background checks) yet the software system when simulation is enabled behave as if the “actual” payment processing or data transfer (background checks) occurred. Any time logging is based on the simulated time. This bypass behavior can occur for other external systems like advertising and background checks. Communication (emails and texts) are able to be processed (sent and received) but when simulation is enabled the data within the system time stamps data based on the simulated clock. Hence emails and texts appear as if they were received at the simulated time. In some implementations, the simulation can enable advertising and lead generation to take place based on the simulated time. This can be accomplished by logging leads against the simulated time. This can be accomplished by leveraging live advertising sites which are real advertisements and just logging leads against simulated time. This can be accomplished by leveraging offline advertising sites which “look” like “real” advertisements but aren't publicly available and logging leads against simulated time. In some implementations, the simulation can enable the ordering of material between suppliers and delivery to the site (supply chain). These behaviors would bypass the actual ordering but enabling simulated logistics based on desired timeline while logging each action against the simulated time. In some implementations, the simulation can enable people movement although it didn't really occur. These behaviors would bypass the actual people (such as tenant, customer, worker, patient, instructor, student movements) movement but enabling simulated people movement based on desired timeline while logging each action against the simulated time.

In general, some implementations can include software simulation methods and systems to validate and test software, where the simulation includes a system clock that can be manipulated including fast forwarding time, pausing time, running time at a faster or slower pace than real time, and jumping back in time, where some clock manipulations create alternate timelines within the simulation.

In some implementations, the simulation provides for creation of things within the context of the physical or virtual process being simulated, notifications and triggered actions, prioritization, communication (emails or texts), applications, leases, contracts, GL entries, payments logged through external or internal logging, and status changes based off system clock.

To facilitate simulation, one or more real actions may be bypassed, for example, by providing an ability to bypass events such as actual ACH payments and credit card payments within a property management simulation. ACH and CC payments can be simulated in some conventional dedicated simulation systems but are not known to be simulated in context of a larger business simulation and necessary simulation time (e.g., simulated real property management, etc.). In some implementations, the simulation methods and systems can provide an ability to immediately apply payment (e.g., ACH) simulation results without built-in “real time” delays.

In some implementations, when integrating with other systems, bypassing “real” responses—that may have a simulation environment, the simulated system clock can be utilized to maintain appropriate synchronization with other systems, which can be an important time conversion constraint when interacting with other systems. This feature can be important from a practical perspective. Current systems have real or imposed time lags that create real time delays prior to receiving acknowledgement. For simulation purposes, the system can provide an ability to create an immediate apply to accelerate testing and training.

Some actions can be bypassed to avoid fees during simulation. For example, in some implementations, the simulation can provide an ability to bypass background checks (and avoid paying per use charge) while providing “viable” data to test or simulate functionality. In another example, the simulation system can provide an ability to bypass advertising for “real” but maintain workflows (and avoid paying a per use charge but provide “viable” data to test functionality). In another example, the simulation system can provide an ability to bypass ordering material for “real” but maintain workflows for coordinating activities.

As mentioned above, in some implementations, simulation time can be initialized and can run faster or slower than real time and can be paused. When paused, a user can interact with the system to view everything and even perform actions. When a user performs an action that updates the system then that action takes place and the simulation clock is updated by a fraction to maintain time alignment avoiding the incorrect behavior of multiple things having the “exact” same time.

The system can support a time jump forward (e.g., fast forward to a point in time and pause). Once paused, the system permits user interaction and actions to be performed while incrementing time by necessary dt to maintain appropriate time alignment. Time jumping again from that point in time can simply continue to the next time.

During fast forward, the system can permit predefined actions (action and time to trigger or event triggers) to be performed during fast forward. The predefined actions can include system reoccurring actions and a que of manually specified actions (e.g., actions from a test or evaluation scenario). The system would behavior as it would during that moment in time.

The simulation system can provide for a time jump backwards. In the first option, the time jump backwards can be positioned from a new point in time where data from previous future time is deleted. In a second option, the time jump backwards can be from a new point in time create and create a second timeline for running and evaluating new scenarios from that point forward, while retaining the first timeline data for comparison or to permit a user to evaluate the first timeline again.

Some implementations can provide the ability to have multiple timelines off multiple timelines. Some implementations can provide the ability for the user's current view to jump between timelines to view, interact, and modify simulation time configurations. When multiple timelines exist the user must “select” which timeline they are altering. Each unique new timeline that's created, by jumping backwards in time, creates an entirely new thread from time zero, such that jumping backward to an earlier time does not “change” already established timelines.

### BRIEF DESCRIPTION OF THE DRAWINGS

FIG. 1 is a block diagram of an example asset management simulation system and a network environment which may be used for one or more implementations described herein.

FIG. 2 is a diagram of an example asset management simulation system and associated functional modules or units in accordance with some implementations.

FIG. 3 is a diagram showing an example portion of asset management simulation processing in accordance with some implementations.

FIG. 4 is a diagram showing an example portion of asset management simulation processing in accordance with some implementations.

FIG. 5 is a diagram showing an example portion of asset management simulation processing in accordance with some implementations.

FIG. 6 is a diagram showing an example asset management simulation graphical user interface in accordance with some implementations.

FIG. 7 is a block diagram of an example computing device in accordance with some implementations.

### DETAILED DESCRIPTION

In general, some implementations can include a simulation system and method for performing a simulation within an asset management system or other “actual” business program used for actually running operations, where the simulation functions are integrated into the asset management system (or other business system) or operate as a standalone simulation coupled to the asset management system. An example use case of an implementation described herein is simulation of management of multi-family or single-family rentals assets within an asset management system, for example as described in U.S. Patent Application No. 63/412,113. This example is used for purposes of illustrating some example aspects of the disclosed subject matter and is not intended to be limiting. There are other use cases or applications that additional features of an implementation can support. For example, some implementations can be configured to support additional use cases including, but not limited to, simulation of management of mobile homes, short term rentals, storage units, commercial properties, so called “fix and flip” properties, design build projects, equipment tracking, farms, equipment heavy industries, and other tangible and intangible assets. The simulation methods and systems described herein can also be applied to business applications including general ledger entries, payments, contracts, project tracking, tracking tasks and details, supply chain, and system communications and notifications, supply chain, and people movement. The simulation methods and systems described herein can also be applied to software development and, in general, any processes that may rely on a time clock or other timeline-based processes.

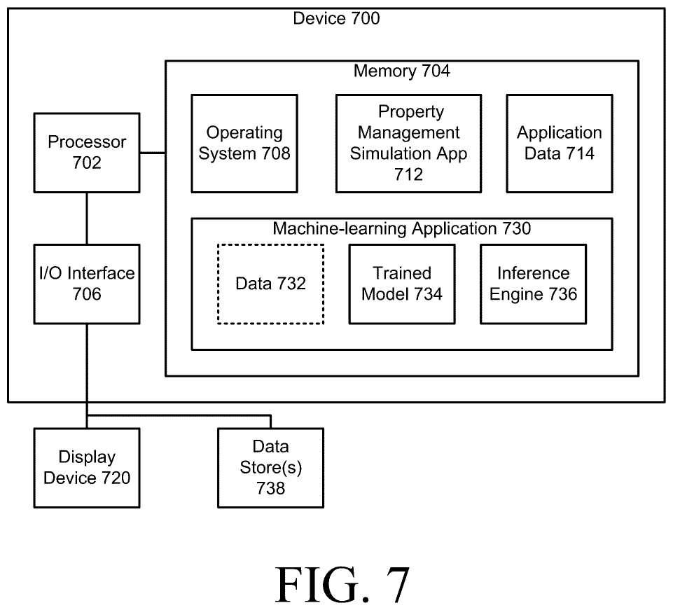

When performing a simulation of asset management functions, it may be helpful for a system to suggest one or more asset management tasks or parameters and/or to make predictions about profitability of an asset. To make predictions or suggestions, a probabilistic model (or other model as described below in conjunction with FIG. 7) can be used to make an inference (or prediction) about aspects of asset management such as profitability or investor return. Accordingly, it may be helpful to make an inference regarding a probability that an asset can be acquired and produce a desired rate of return on capital (or other measure of investment or business performance). Other aspects of an asset under consideration for acquisition or under management can be predicted or suggested as described below.

The inference based on the probabilistic model can include predicting potential asset profitability, investment return, or the like in accordance with asset management parameters (or other data) analysis and confidence score as inferred from the probabilistic model. The probabilistic model can be trained with data including previous asset management data. Some implementations can include generating asset management predictions based on asset management parameters. The inference can also include a recommendation to apply an action based on a result of the simulation.

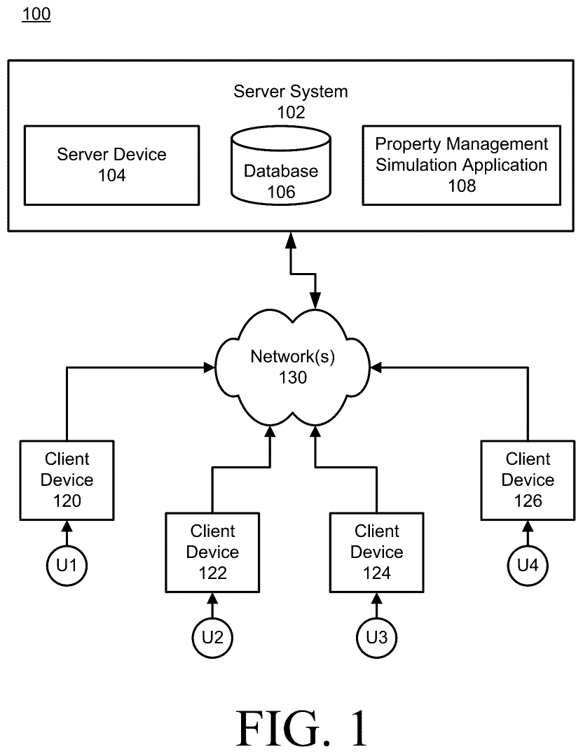

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106 or other data store or data storage device, and an asset management simulation application 108. The asset management application can manage or be associated with one or more items or users (132-136). For example, the asset management application can be configured to manage assets (e.g., real estate assets, investments, etc.) or any physical or virtual asset that may benefit from an asset management application or system. Network environment 100 also can include one or more client devices, e.g., customer devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, database 106, and asset management application 108, and shows four blocks for customer devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, embedded system, medical equipment, programmable logic controllers (PLCs), connected sensors, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective customer devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective customer devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on customer devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more customer devices 120-126 can provide asset management functions and asset management simulation functions as described herein.

Various implementations of features described herein can use any type of system and/or service. Any type of electronic device can make use of the features described herein. Some implementations can provide one or more features described herein on customer (client) or server devices disconnected from or intermittently connected to computer networks.

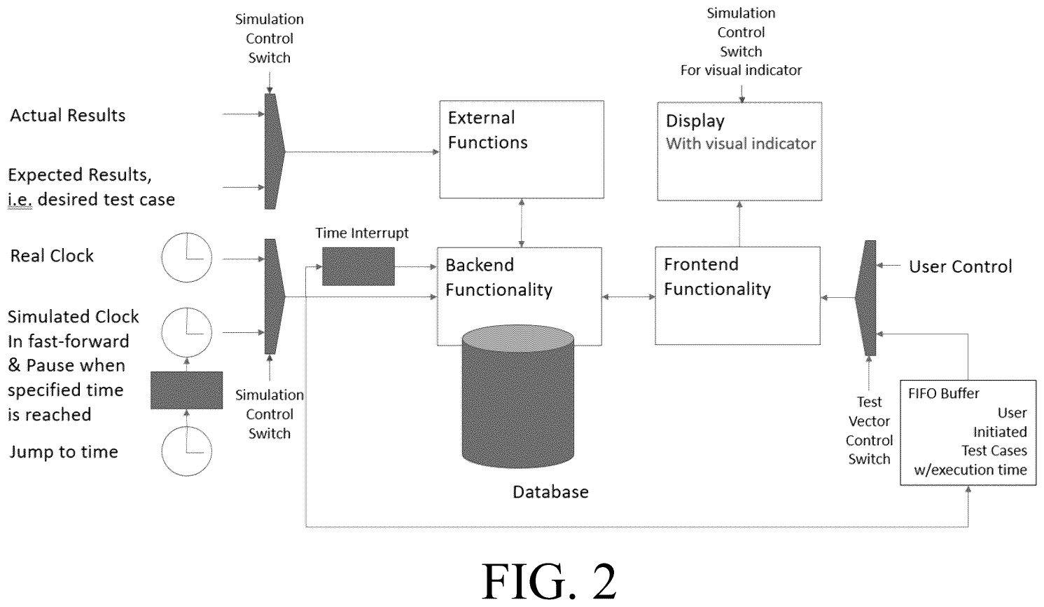

FIG. 2 is a diagram of an example asset management simulation system and associated functional modules or units in accordance with some implementations. In particular, FIG. 2 shows simulation control switches that can switch between “real” asset management functions (i.e., not simulated) and simulated asset management functions.

Specifically, the software simulation switches can control switching between actual results (or input data) and expected results or desired test case data. The software simulation switches can also switch between a real clock (i.e., chronological time) or a simulated clock that can move ahead or backward in time at a rate different than real time and can be paused, stepped or otherwise moved in ways that are different than the natural progression of real time. The simulated clock can also be used to jump to a given time, at a rate different than real time, and pause. When paused or clock running at a rate different than real time a user can interact with the system through the GUI to view and execute commands. The software simulation shall also provide methods to align multiple clocks from external systems such as providing necessary offsets or producing a clock signal to computer generated graphic simulation for synchronization.

In some implementations, a data structure can be configured to track the simulation of the asset management system. The simulation system can be configured to jump backwards in time to a specific moment. At that point, the simulation software can perform one of two functions. It would either create a secondary branch for the new data which would create a new timeline and data for the system to work on, or the simulation software could remove the previous data from that point in time and create a new series of events.

Architecturally, the same or similar structure provides the simulation ability to go backward in time or systematically step through what has historically happened during the simulation, which can permit a user to view the actions that have led up to the that point in time.

The simulated clock is provided to the back-end functionality section of an asset management system that is coupled to an external functions section (e.g., including APIs, or other interfaces, etc.) and a frontend functionality section. The backend functionality section of the simulation software can be configured to perform desired core asset management system functionality. In some implementations, the core functionality can include one or more of: cloud-based infrastructure, user access and role definition, asset definition, GL codes, expenses, applicant lead, application, leases, charges, payments, simulation, notifications, tasks, task prioritization, email, texting, checklists, calendar, Gannt charts, and/or reports. In some implementations, such as the business application simulation discussed above, the core functionality can include general ledger entries, payments, contracts, project tracking, details, supply chain flow of good, system communications and notifications, supply chain, and people movement.

The simulation software runs off a global clock GMC. In simulation mode, a global clock is recreated and can be used to manipulate the simulation time. Actions or other items in the simulation are entered relative to the simulation time. A new simulation instance can define the initial time such that it can have the same starting point. From a user perspective, time zone compensation is accounted for in a way similar to a real (i.e., non-simulated) system.

A second method of performing a simulation can include test vectors with results or commands to be executed at a given time by creating offset time deltas applied relative to an arbitrary starting time of the simulation clock.

The backend functionality section is coupled to a simulation database configured to store simulation data such as test vectors, simulation results, etc. The simulation database can also store a separate data set corresponding to the asset management software data for an asset that the management of is being simulated. The simulation database would either be initialized with the current data set with a secondary set of data that would remain until the simulation was terminated, or upon terminating the simulation the data can be destroyed. In some implementations, simulation data can be retained, such as when a user creates multiple timelines within the simulation. Data for the multiple timelines can be retained so that the use can “hop” between timelines for comparison or other analysis purposes.

The external functions section is also coupled to an input path of actual results from external systems or expected results (e.g., desired test cases) when used in simulation mode. External functions include those actions associated with utilizing an API to interface with external systems such as an external advertisement site (e.g., to push info to advertise and for applicants to directly send a request to be considered as an applicant which comes into an applicant list), background checks (e.g., to push into and receive personal information from credit agencies, or other background check sources), money transfer mechanisms (e.g., to electronically transfer funds through bank transfers, debt cards, or credit cards), communications, lead generation, supply chain, and people movement. The external events can be interfaced through the backend functionality section to provide external functions, compensating for time variations between each system, or actions as requested through the front end based on user inputs or test cases/test vector inputs.

The front-end functionality section is coupled to a test vector control switch that is configured to switch in user input or inputs from a buffer (e.g., a FIFO buffer, or the like) of user-initiated test cases with associated execution times. In some implementations, a test vector includes a scripted list of things a user would typically do but scheduled to automatically execute at the specified time. By using test vectors, the simulation software can be completely automated instead of stopping and waiting for a user to do something in a fast forward test.

### Example Test Vectors:

On Jan. 1, 2023 at 01:22:00 (command to create applicant)
On Jan. 1, 2023 at 01:22:00 (command to enter applicant name) “name”
On Jan. 1, 2023 at 01:22:00 (command to enter applicant phone number) “111-111-1111”
On Jan. 1, 2023 at 01:22:00 (command to enter applicant email) “temp@gmail.com”
On Jan. 1, 2023 at 01:22:00 (command to create lease with applicant “name” and unit “name”)
On Jan. 1, 2023 at 01:22:00 (command to enter lease start date) “start date”
On Jan. 1, 2023 at 01:22:00 (command to enter lease end date) “end date”
On Jan. 1, 2023 at 01:22:00 (command to enter lease rent amount) “$amount”
On Jan. 1, 2023 at 01:22:00 (command to enter lease late fee) “$amount”
On Jan. 1, 2023 at 01:22:00 (command to enter lease month to month fee) “$amount”
On Jan. 1, 2023 at 01:22:00 (command to upload lease document) “file”
On Jan. 1, 2023 at 01:22:00 (command to pay lease deposit) “$amount”
On Jan. 1, 2023 at 01:22:00 (command to place lease)

Simulation input events or actions can be organized into templates. The simulation software can provide this functionality in one of two ways: (1) Create a test vector to generate the desired repeatable actions or (2) utilize a “canned” test scenario where a base setup is automatically created.

The buffer is also coupled to a time interrupt module that can provide actions to the backend functionality section based on simulation time. In some implementations, the time interrupts can include actions such as:
Apply scheduled Tasks on x date
Apply lease payments due on x date
Apply rents & other charges
Apply late fees
Apply month to month fees
Apply deposits due
Apply notifications once per day based on
Performance KPIs
Leasing actions & KPIs
Task actions & KPIs

A display showing a graphical user interface (GUI) with a visual simulation indicator is coupled to the frontend functionality section. The GUI can include a user interface element to select simulation mode and to indicate when the asset management system is operating in simulation mode.

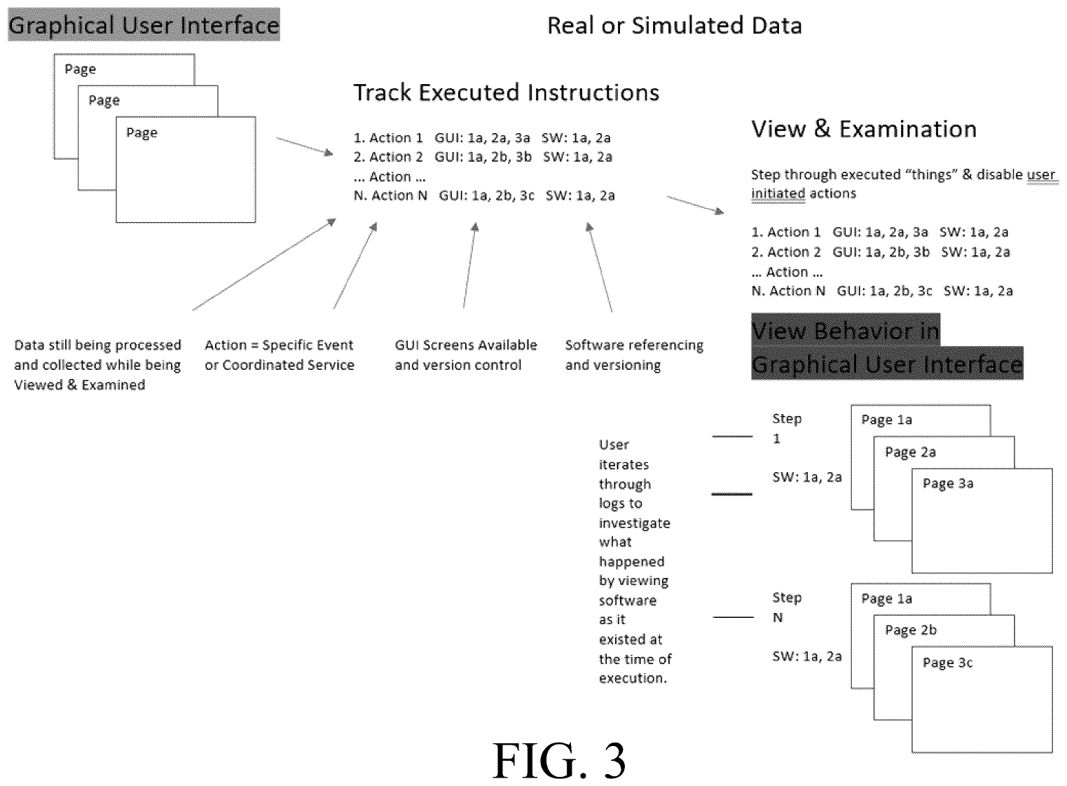

FIG. 3 is a diagram showing an example portion of asset management simulation processing in accordance with some implementations. In particular, FIG. 3 shows the relationship between tracked execution instructions corresponding to user actions or simulated user actions. The tracked execution instructions can be viewed and examined.

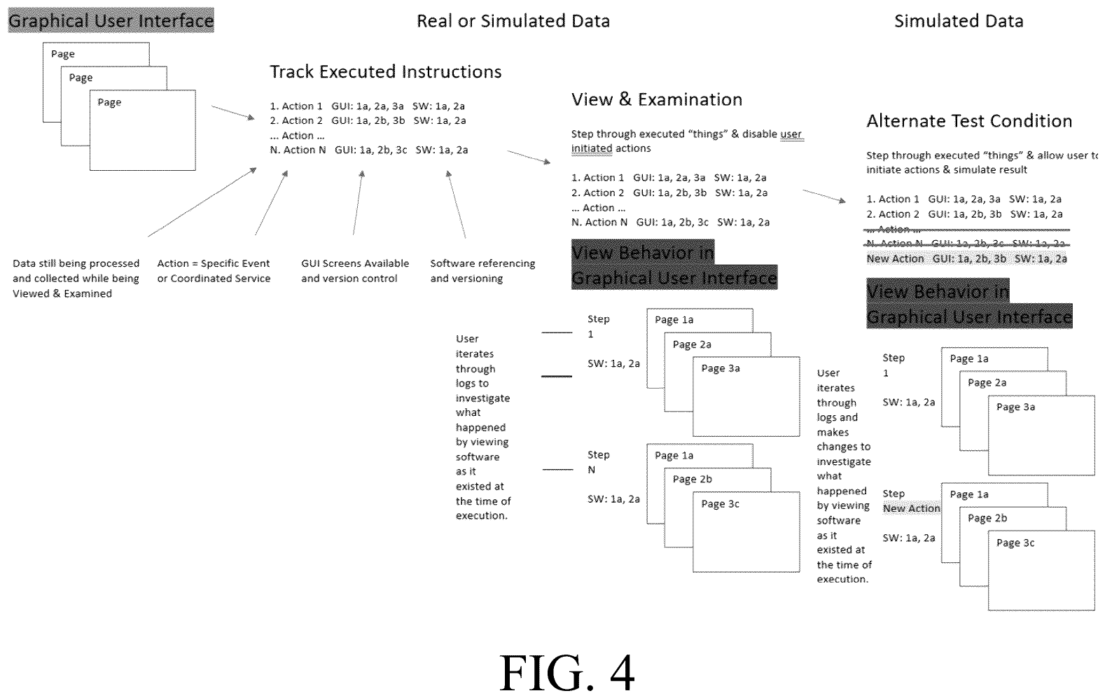

FIG. 4 is a diagram showing an example portion of asset management simulation processing in accordance with some implementations. In particular, FIG. 4 shows an example of an alternate test condition (e.g., a user input to the simulation or a test vector input or the like to the simulation) and viewing that alternate test condition behavior in a graphical user interface. The alternate test condition can include replacing Action N with a New Action as shown in the Alternate Test Condition section.

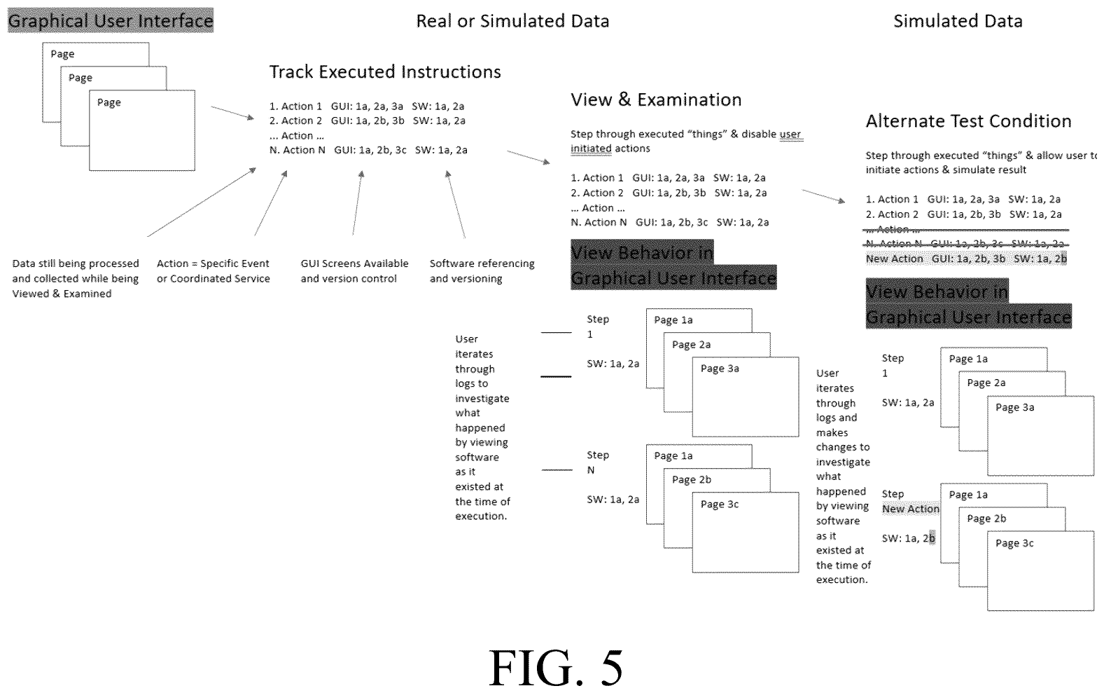

FIG. 5 is a diagram showing an example portion of asset management simulation processing in accordance with some implementations. In FIG. 5, a software parameter in the New Action is changed from “2a” to “2b.” The result of this change is visible to the user via the GUI as the simulation proceeds to the step: New Action where the new software referencing/versioning parameter 2b is processed.

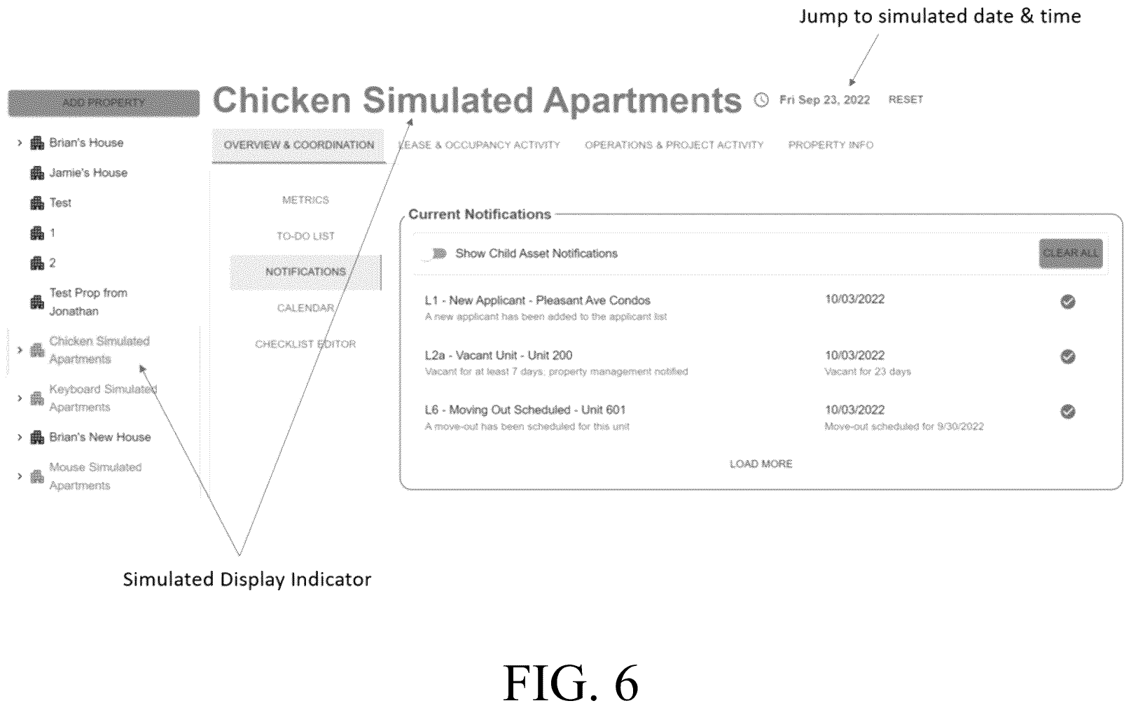

FIG. 6 is a diagram showing an example asset management simulation graphical user interface in accordance with some implementations. In particular, FIG. 6 shows the GUI indication of a simulation using one or more of a simulated display indicator on the left side tree view and in the top bar name of the selected simulation. In this case the selected simulation is “Chicken Simulated Apartments.” The simulation GUI contains the same features as the non-simulated asset management system such as tabs for Overview & Coordination, Lease & Occupancy Activity, Operations & Project Activity, and Property Info. The simulation GUI also includes a date and time element that shows the current simulation date and time and can be used to jump to a desired date and time for simulation analysis purposes. In simulation mode, the Overview & Coordination tab includes selections for Metrics, To-Do List, Notifications, Calendar, and Checklist Editor. Current Notifications are displayed in the simulation based on the current simulation date and time.

An important feature to note in FIG. 6 is that the asset management system includes both real assets under management (in black) and simulated asset management scenarios (in orange). By having an asset management system with both real (or live) management and simulated management in one system, users can analyze the effects of decisions in the simulation side using data from the real management operations side. This can provide a simulation that produces results that accurately represent the asset for which management is being simulated.

FIG. 7 is a block diagram of an example device 700 which may be used to implement one or more features described herein. In one example, device 700 may be used to implement a client device, e.g., any of customer devices 120-126 shown in FIG. 1. Alternatively, device 700 can implement a server device, e.g., server device 104, etc. In some implementations, device 700 may be used to implement a client device, a server device, or a combination of the above. Device 700 can be any suitable computer system, server, or other electronic or hardware device as described above.

One or more methods described herein (e.g., FIGS. 2-5) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 700 includes a processor 702, a memory 704, and I/O interface 706. Processor 702 can be one or more processors and/or processing circuits to execute program code and control basic operations of the device 700. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 702 may include one or more co-processors that implement neural-network processing. In some implementations, processor 702 may be a processor that processes data to produce probabilistic output, e.g., the output produced by processor 702 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, machine-learning application 730, asset management simulation application 712, and application data 714. Other applications may include applications such as a data display engine, web hosting engine, image display engine, notification engine, social networking engine, etc. In some implementations, the machine-learning application 730 and asset management simulation application 712 can each include instructions that enable processor 702 to perform functions described herein, e.g., some or all of the method of FIG. 7.

The machine-learning application 730 can include one or more NER implementations for which supervised and/or unsupervised learning can be used. The machine learning models can include multi-task learning based models, residual task bidirectional LSTM (long short-term memory) with conditional random fields, statistical NER, etc. The Device 700 can also include an asset management simulation application 712 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 730 may utilize Bayesian classifiers, support vector machines, neural networks, or other learning techniques. In some implementations, machine-learning application 730 may include a trained model 734, an inference engine 736, and data 732. In some implementations, data 732 may include training data, e.g., data used to generate trained model 734. For example, training data may include any type of data suitable for training a model for asset management tasks, such as parameters, labels, thresholds, etc. associated with asset management tasks described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 734, training data may include such user data. In implementations where users permit use of their respective user data, data 732 may include permitted data.

In some implementations, data 732 may include collected data such as asset management parameters, asset management system data, etc. In some implementations, training data may include synthetic data generated for the purpose of training, such as data that is not based on user input or activity in the context that is being trained, e.g., data generated from simulated conversations, computer-generated images, etc. In some implementations, machine-learning application 730 excludes data 732. For example, in these implementations, the trained model 734 may be generated, e.g., on a different device, and be provided as part of machine-learning application 730. In various implementations, the trained model 734 may be provided as a data file that includes a model structure or form, and associated weights. Inference engine 736 may read the data file for trained model 734 and implement a neural network with node connectivity, layers, and weights based on the model structure or form specified in trained model 734.

Machine-learning application 730 also includes a trained model 734. In some implementations, the trained model 734 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 732 or application data 714. Such data can include, for example, asset management actions, external events, asset financial data, and asset management internal events, e.g., when the trained model is used for asset management simulation functions. Subsequent intermediate layers may receive as input output of nodes of a previous layer per the connectivity specified in the model form or structure. These layers may also be referred to as hidden layers. A final layer (e.g., output layer) produces an output of the machine-learning application. In some implementations, model form or structure also specifies a number and/or type of nodes in each layer.

In different implementations, the trained model 734 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 734 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 732, to produce a result.

For example, training may include applying supervised learning techniques. In supervised learning, the training data can include a plurality of inputs (e.g., a set of images, electronic notes, data structures, etc. related to an asset) and a corresponding expected output for each input (e.g., predictions or suggestions representing aspects of an asset management project such as services, products, or operational actions needed or recommended). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to predict asset management parameters and/or select thresholds for parameters.

In another example, a model trained using unsupervised learning may cluster words based on the use of the words in data sources. In some implementations, unsupervised learning may be used to produce knowledge representations, e.g., that may be used by machine-learning application 730. In various implementations, a trained model includes a set of weights, or embeddings, corresponding to the model structure. In implementations where data 732 is omitted, machine-learning application 730 may include trained model 734 that is based on prior training, e.g., by a developer of the machine-learning application 730, by a third-party, etc. In some implementations, trained model 734 may include a set of weights that are fixed, e.g., downloaded from a server that provides the weights.

Machine-learning application 730 also includes an inference engine 736. Inference engine 736 is configured to apply the trained model 734 to data, such as application data 714, to provide an inference. In some implementations, inference engine 736 may include software code to be executed by processor 702. In some implementations, inference engine 736 may specify circuit configuration (e.g., for a programmable processor, for a field programmable gate array (FPGA), etc.) enabling processor 702 to apply the trained model. In some implementations, inference engine 736 may include software instructions, hardware instructions, or a combination. In some implementations, inference engine 736 may offer an application programming interface (API) that can be used by operating system 708 and/or asset management simulation application 712 to invoke inference engine 736, e.g., to apply trained model 734 to application data 714 to generate an inference.

Machine-learning application 730 may provide several technical advantages. For example, when trained model 734 is generated based on unsupervised learning, trained model 734 can be applied by inference engine 736 to produce knowledge representations (e.g., numeric representations) from input data, e.g., application data 714. For example, a model trained for asset management tasks may produce predictions and confidences for given input information about an asset management project being proposed or planned. A model trained for predicting asset management parameters may produce a suggestion for one or more parameters of an asset management program. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 736.

In some implementations, knowledge representations generated by machine-learning application 730 may be provided to a different device that conducts further processing, e.g., over a network. In such implementations, providing the knowledge representations rather than the raw data may provide a technical benefit, e.g., enable faster data transmission with reduced cost.

In some implementations, machine-learning application 730 may be implemented in an offline manner. In these implementations, trained model 734 may be generated in a first stage and provided as part of machine-learning application 730. In some implementations, machine-learning application 730 may be implemented in an online manner. For example, in such implementations, an application that invokes machine-learning application 730 (e.g., operating system 708, one or more of asset management simulation application 712 and/or other applications) may utilize an inference produced by machine-learning application 730, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 734, e.g., to update embeddings for trained model 734.

In some implementations, machine-learning application 730 may be implemented in a manner that can adapt to particular configuration of device 700 on which the machine-learning application 730 is executed. For example, machine-learning application 730 may determine a computational graph that utilizes available computational resources, e.g., processor 702. For example, if machine-learning application 730 is implemented as a distributed application on multiple devices, machine-learning application 730 may determine computations to be carried out on individual devices in a manner that optimizes computation. In another example, machine-learning application 730 may determine that processor 702 includes a GPU with a particular number of GPU cores (e.g., 1000) and implement the inference engine accordingly (e.g., as 1000 individual processes or threads).

In some implementations, machine-learning application 730 may implement an ensemble of trained models. For example, trained model 734 may include a plurality of trained models that are each applicable to same input data. In these implementations, machine-learning application 730 may choose a particular trained model, e.g., based on available computational resources, success rate with prior inferences, etc. In some implementations, machine-learning application 730 may execute inference engine 736 such that a plurality of trained models is applied. In these implementations, machine-learning application 730 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 708 or one or more other applications, e.g., asset management simulation application 712.

In different implementations, machine-learning application 730 can produce different types of outputs. For example, machine-learning application 730 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 730 may produce an output video with a particular effect applied, e.g., rendered in a comic-book or particular artist's style, when trained model 734 is trained using training data from the comic book or particular artist, etc. In some implementations, machine-learning application 730 may produce an output based on a format specified by an invoking application, e.g., operating system 708 or one or more applications, e.g., asset management simulation application 712. In some implementations, an invoking application may be another machine-learning application. For example, such configurations may be used in generative adversarial networks, where an invoking machine-learning application is trained using output from machine-learning application 730 and vice-versa.

Any of software in memory 704 can alternatively be stored on any other suitable storage location or computer-readable medium. In addition, memory 704 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. Interfaced devices can be included as part of the device 700 or can be separate and communicate with the device 700. For example, network communication devices, storage devices (e.g., memory and/or database 106), and input/output devices can communicate via I/O interface 706. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 706 can include one or more display devices 720 and one or more data stores 738 (as discussed above). The display devices 720 that can be used to display content, e.g., a user interface of an output application as described herein. Display device 720 can be connected to device 700 via local connections (e.g., display bus) and/or via networked connections and can be any suitable display device. Display device 720 can include any suitable display device such as an LCD, LED, or plasma display screen, CRT, television, monitor, touchscreen, 3-D display screen, or other visual display device. For example, display device 720 can be a flat display screen provided on a mobile device, multiple display screens provided in a goggles or headset device, or a monitor screen for a computer device.

The I/O interface 706 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 7 shows one block for each of processor 702, memory 704, I/O interface 706, and software blocks 708, 712, and 730. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While some components are described as performing blocks and operations as described in some implementations herein, any suitable component or combination of components of environment 100, device 700, similar systems, or any suitable processor or processors associated with such a system, may perform the blocks and operations described.

In some implementations, the asset management system can include a machine-learning model (as described herein) for tuning the system (e.g., selecting asset management parameters and corresponding thresholds) to potentially provide improved accuracy. Example machine-learning model input can include labels for a simple implementation and can be augmented with descriptor vector features for a more advanced implementation. Output of the machine-learning module can include a prediction of asset management parameters, asset growth or profitability.

One or more methods described herein (e.g., method 200 and/or 300) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
generating, in a real property asset management system, an asset data structure corresponding to an asset;
populating, in the real property asset management system, the asset data structure with data corresponding to one or more aspects of the real property, wherein the data includes one or more of actual data or simulated data;
simulating, in the real property asset management system, one or more values associated with the real property based on the data and a time lapse of a system clock, wherein the system clock is advanced at a real time rate or at a rate different than real time; and
displaying the one or more values resulting from the simulating.

2. A computer-implemented method, comprising:
generating, in an asset management system, an asset data structure corresponding to an asset, wherein the asset is a real property, and wherein one or more components of the data structure correspond to one or more physical elements of the asset;
generating a tree view of the asset data structure including one or more visual elements based on data in the asset data structure, wherein the tree view includes a hierarchical arrangement of graphical user interface elements corresponding to a physical hierarchy within the asset;
populating the asset data structure with data corresponding to one or more aspects of the real property, wherein the data includes one or more of actual data or simulated data;
simulating, in the real property asset management system, one or more values associated with the real property based on the data and a time lapse of a system clock, wherein the system clock is advanced at a real time rate or at a rate different than real time; and
displaying the one or more values resulting from the simulating in the tree view.

3. The computer-implemented method of claim 1, further comprising defining a simulation start time including one or more of a date and a time of day.

4. The computer-implemented method of claim 3, further comprising:
defining a simulation stop time, including one or more of a date and a time of day; and
advancing the simulating to the simulation stop time and pause to display simulation results at the simulation stop time,
wherein during the advancing, one or more scheduled actions is generated, one or more scheduled actions based on a test vector is applied to simulate internal or external actions, and
wherein when the simulation is paused, permitting a user to navigate through the property management system in simulation mode and execute commands.

5. The computer-implemented method of claim 4, further comprising repeating the defining and the advancing for one or more additional cycles associated with respective simulation stop times.

6. The computer-implemented method of claim 3, further comprising displaying an indicator that simulation mode is active when a simulation is being executed.

7. The computer-implemented method of claim 2, further comprising updating the tree view based on simulation results.

8. The computer-implemented method of claim 3, further comprising triggering one or more interrupt activities based on a simulated time value and aligning clocks as necessary.

9. The computer-implemented method of claim 3, further comprising bypassing one or more external events when a simulation is being executed and providing an ability to return expected data from the one or more bypassed external events for desired test behavior.

10. The computer-implemented method of claim 3, further comprising defining one or more test vectors, each having an execution time and one or more values, for use in a simulation, wherein each entry within each test vector is executed at the specified execution time to test the system.

11. The computer-implemented method of claim 3, wherein the simulating includes simulating events including one or more of a user access and role definition, asset definition, GL code entries, applicant lead, application, lease action, a lease payment, a one-time charge, a scheduled task, a simulation vector task, a task when simulation paused or stopped, a scheduled expense, an expense from a simulation test vector, an expense when simulation paused or stopped, task prioritization including one or more of asset, category, user, or type, payments for tasks or services, a notification based on simulated time, an advertising result, parts inventory, material inventory, and a communication task based on simulated time, calendars, Gannt charts, reports, tenant move in and move out.

12. The computer-implemented method of claim 9, wherein the one or more bypass events includes one or more of a background check, advertising, a funds transfer, and part ordering.

13. The computer-implemented method of claim 3, further comprising reversing the simulated time at a rate different than real time.

14. The computer-implemented method of claim 13, further comprising:
defining a simulation stop time, including one or more of a date and a time of day;
reversing the simulating to the simulation stop time and pausing to display simulation results at the simulation stop time;
restarting the simulated clock; and
performing one of eliminating a previous timeline prior to the reversing or creating a new timeline to move forward from after the reversing,
wherein when the simulation is paused, permitting a user to navigate through the property management system in simulation mode and execute commands.

15. A computer-implemented method comprising:
generating a data structure corresponding to a business process or entity;
populating the data structure with data corresponding to one or more aspects of the business process or entity, wherein the data includes one or more of actual data or simulated data;
simulating one or more values associated with the real property based on the data and a time lapse of a system clock, wherein the system clock is advanced at a real time rate or at a rate different than real time; and
displaying the one or more values resulting from the simulating.

16. The computer-implemented method of claim 15, further comprising defining a simulation start time including one or more of a date and a time of day.

17. The computer-implemented method of claim 16, further comprising:
defining a simulation stop time, including one or more of a date and a time of day; and
advancing the simulating to the simulation stop time and pause to display simulation results at the simulation stop time,
wherein during the advancing, one or more scheduled actions is generated, one or more scheduled actions based on a test vector is applied to simulate internal or external actions, and
wherein when the simulation is paused, permitting a user to navigate through a system associated with the business process or entity in simulation mode and execute commands.

18. The computer-implemented method of claim 17, further comprising repeating the defining and the advancing for one or more additional cycles associated with respective simulation stop times.

19. The computer-implemented method of claim 18, further comprising bypassing one or more external events when a simulation is being executed and providing an ability to return expected data from the one or more bypassed external events for desired test behavior.

20. The computer-implemented method of claim 19, further comprising defining one or more test vectors, each having an execution time and one or more values, for use in a simulation, wherein each entry within each test vector is executed at the specified execution time to test the system.
